(19) United States
(12) Patent Application Publication
(10) Pub. No.: US 2014/0280804 A1
(43) Pub. Date: Sep. 18, 2014

(54) RELATIONSHIP DRIVEN DYNAMIC WORKFLOW SYSTEM

(71) Applicant: DELL PRODUCTS L.P., Round Rock, TX (US)

(72) Inventors: Brahmananda R. Thodati, Round Rock, TX (US); Saikrishna M. Kotha, San Jose, CA (US)

(73) Assignee: Dell Products L.P., Round Rock, TX (US)

(21) Appl. No.: 13/798,860

(22) Filed: Mar. 13, 2013

(51) Int. Cl. H04L 12/24

(52) U.S. Cl. CPC H04L 41/0806
USPC 709/222

(57) ABSTRACT

A networked system includes a first information handling system (IHS) including a plurality of first IHS components and a second IHS coupled to the first IHS. A system management IHS is coupled to the first IHS and operable to discover the first IHS and the second IHS. The system management IHS then determines a plurality of relationships between the first IHS components and the second IHS and stores the plurality of relationships. The system management IHS then determines that the second IHS requires configuration. The system management IHS then determines that the at least some of the first IHS components have a relationship with the second IHS using the plurality of relationships. The system management IHS then sends an instruction to configure the at least some of the first IHS components having the relationships with the second IHS according to the configuration required for the second IHS.

### BACKGROUND

The present disclosure relates generally to information handling systems, and more particularly to a system for providing dynamic workflows based on relationships between information handling systems and information handling system components.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHSs are sometimes networked to provide networked systems that may be managed by an administrator. Management of a networked system may be accomplished using system management applications that allow the administrator to monitor the IHSs and their components in the networked system. However, with the increase in the capabilities of IHSs, system management applications for networked systems have become more and more complex in order to allow administrators to effectively manage the IHSs and their components in the networked system. Conventional system management applications typically attempt to categorize the management requirements of networked systems up-front (e.g., during development of the system management application), and then allow administrators to access a pre-determined set of views of the networked system in order to manage the IHSs and their components. As such, the provision and integration between the views of the networked system is static and pre-determined as part of the application development process. Thus, conventional system management applications may be deficient in providing administrators management abilities according to their specific needs, and may provide views of the networked system that are not needed while also collecting data that may be desirable but not viewable due to the decisions made about which views to provide through the system management application.

Accordingly, it would be desirable to provide an improved system management application for managing a networked system.

### SUMMARY

According to one embodiment, a networked system includes a first information handling system (IHS) including a plurality of first IHS components; a second IHS coupled to the first IHS; a system management IHS coupled to the first IHS and operable to: discover the first IHS and the second IHS; determine a plurality of relationships between the first IHS components and the second IHS; store the plurality of relationships; determine that the second IHS requires configuration; determine that the at least some of the first IHS components have a relationship with the second IHS using the plurality of relationships; and send an instruction to configure the at least some of the first IHS components having the relationships with the second IHS according to the configuration required for the second IHS.

### BRIEF DESCRIPTION OF THE DRAWINGS

FIG. 1 is a schematic view illustrating an embodiment of an information handling system.

FIG. 2 is a schematic view illustrating an embodiment of a networked system.

FIG. 3 is a flow chart illustrating an embodiment of a method for managing a networked system.

FIG. 4 is a graph view illustrating relationships in a networked system.

FIG. 5 is a graph view illustrating a workflow dynamically created for a networked system.

FIG. 6 is a front view illustrating a system management IHS displaying a networked system reporting screen according to the dynamic workflow illustrated in FIG. 5.

FIG. 7 is a graph view illustrating a workflow dynamically created for a networked system.

FIG. 8 is a front view illustrating a system management IHS displaying a networked system reporting screen according to the dynamic workflow illustrated in FIG. 7.

FIG. 9 is a graph view illustrating a workflow dynamically created for a networked system.

FIG. 10 is a front view illustrating a system management IHS displaying a networked system reporting screen according to the dynamic workflow illustrated in FIG. 9.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a display device or monitor, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

Referring now to FIG. 2, an embodiment of a networked system 200 is illustrated. In the illustrated embodiment, the networked system 200 includes a system management IHS 202 coupled to a networking IHS 204 that is coupled to client IHSs 206 either directly or through a port extender (PE) IHS 208. One of skill in the art will recognize the illustrated embodiment of the networked system 200 as a very simple networked system with few components that has been provided herein for clarity of illustration and discussion, and that much more complicated networked systems with many more components will fall within the scope of the present disclosure. In an embodiment, the system management IHS 202 may include some or all of the components of the IHS 100, discussed above with reference to FIG. 1. For example, the system management IHS 202 may be a portable/laptop/notebook IHS, a desktop IHS, and/or a variety of other IHSs. The system management IHS 202 includes a system management application 202a that may be provided by instructions that are stored on a memory system (e.g., the system memory 114 and/or the storage device 108 discussed above with reference to FIG. 1, or other non-transitory computer-readable mediums known in the art) and that, when executed by a processing system (e.g., the processor 102 discussed above with reference to FIG. 1) cause the processing system to perform the functions of the system management IHS 202 and the system management application 202a discussed below.

The system management IHS 202 may be coupled to the networking IHS 204 directly (e.g., through a direct wired or wireless connection), over a network (e.g., a local area network (LAN), the Internet, etc.), and/or in a variety of methods known in the art. As such, each of the system management IHS 202 and networking IHS 204 include communications systems and communications interface that are not shown in FIG. 2 for clarity of illustration and discussion. In an embodiment, the networking IHS 204 may include some or all of the components of the IHS 100, discussed above with reference to FIG. 1. For example, the networking IHS 202 in the illustrated embodiment is a switch IHS that includes a route processor module (RPM) 204a that is coupled to a plurality of line modules (LMs) 204b, 204c, 204d, and 204e. One of skill in the art will recognize the illustrated embodiment of the networking IHS 204 as a very simple switch IHS with few components that has been provided herein for clarity of illustration and discussion, and that much more complicated switch IHSs including, for example, additional RPMs, LMs, and other switch components known in the art will fall within the scope of the present disclosure. While not explicitly illustrated in FIG. 2, each of the line modules 204b, 204c, 204d, and 204e include ports through which they may be connected to the client IHSs 206, either directly as illustrated with the line module 204e, or indirectly through the port extender 208 as illustrated with the line module 204b.

In an embodiment, the client IHSs 206 may include some or all of the components of the IHS 100, discussed above with reference to FIG. 1. For example, the client IHSs 206 may be portable/laptop/notebook IHSs, desktop IHSs, server IHSs, storage IHSs, and/or a variety of other IHSs known in the art. In other embodiments, the client IHs 206 may include wireless access points that are operable to provide connections to the networked system 200 to a variety of IHSs known in the art. In an embodiment, the port extender IHS 208 may include some or all of the components of the IHS 100, discussed above with reference to FIG. 1. For example, the port extender IHS 208 may be an IHS that connects to one or more ports on the line module 204b and provides additional ports for the connection of client IHSs 206 in order to increase or “extend” the number of ports on the networking HIS 204.

Referring now to FIG. 3, an embodiment of a method 300 for managing a networked system is illustrated. In an embodiment, the method 300 is performed by the system management application 202a in the system management IHS 202 to record or “graph” the relationships in the networked system 200 in order to, for example, allow the dynamic determination and capturing of workflows. As discussed in further detail below, the dynamic determination and capturing of workflows is enabled by discovering the relationships between devices and device components in the networked system 200, which also enables for the rapid determination and in some cases automation of multiple device configurations based on a required configuration for one device, navigation between devices in the networked system 200, consolidation and correlation of alarms in the networked system 200, and device searching throughout the networked system 200.

The method 300 begins at block 302 where devices and device components in a networked system are discovered. Referring to FIG. 2, the system management application 202a on the system management IHS 202 may perform block 302 of the method 300 upon connection to the networking IHS 204 to discover the route processor module 204a and the line modules 204b, 204c, 204d, and 204e in the networking IHS 204, the port extender IHS 208, and the client IHSs 206. In an embodiment, the discovery of devices and device components in the networked system 200 may be accomplished by the system management application 202a through the communication between each of the devices in the networked system and the system management application 202a. For example, an administrator may trigger the discovery of the network and/or one or more of its devices by entering in an Internet Protocol (IP) address or IP addresses of the device(s) and leveraging standard protocols implemented by the device(s) such as, for example, the Simple Network Management Protocol (SNMP). In another example, a device in the network such as the port extender IHS 208 or the client IHSs 206, etc. may be connected to the networking IHS 204 and, in response, may publish its IP address such that its IP address is transmitted to the system management application 202a. The system management application 202a may then use that IP address to discover that device, along with other devices connected to that device.

The method 300 then proceeds to block 304 where relationships between devices and device components are determined. Referring to FIG. 2, the system management application 202a on the system management IHS 202 may perform block 304 of the method 300 either simultaneously with block 302 or following block 302. At block 304, the system management application 202a may determine the physical connectivity relationships between the devices in the networked system 200, including the connections between the route processor module 204a and the line modules 204b, 204c, 204d, and 204e in the networking IHS 204, the connection between the port or ports on the line module 204b and the port extender IHS 208, the connection between the port on the port extender 208 and the client IHS 206, and the connection between the port on the line module 204e and the client IHS 206. In an embodiment, the determination of the relationships between the devices and device components in the networked system 200 may be accomplished by the system management application 202a through the communication between each of the devices in the networked system and the system management application 202a. For example, relationships may be established based on a similarity in the nature of devices (and/or their components) in the system 200, the type of devices (and/or their components) in the system 200, the proximity of devices (and/or their components) in the system 200, the functionality of devices (and/or their components) in the system 200, and/or a variety of other relationship characteristics known in the art. In an embodiment relationships may be established between devices (and/or their components) based on characteristics that cause those devices to require similar management operations (e.g., configuration operations) for their optimal functioning.

For example, referring to FIG. 2, relationships between devices and/or their components may include relationships based on physical connectivity between the client IHSs 206, relationships based on the line modules 204b, 204c, 204d, and 204e being the same type of line modules, relationships based on the co-location of the line modules 204b, 204c, 204d, and 204e (e.g., in networking IHS 204, in the same laboratory, etc.) and/or their connection to a co-located device, relationships based on the client IHSs 206 each providing wireless access point functionality, etc. A relationship between devices may include a logical connection (e.g., the logical links that connects the client IHSs 206) or communication (e.g., the path used to communicate between the client IHSs 206.) A specific example of a relationship in the networked system 200 would be based on the physical connections that connect client IHS 206, the type of line modules connected to the client IHSs 206, and the paths used to communicate between the client IHSs 206.

The method 300 then proceeds to block 306 where a relationship-based graph is created. Referring to FIGS. 2 and 4, the system management application 202a uses the devices and device components discovered in block 302 along with the relationships determined in block 304 to create a relationship based graph 400. As can be seen from the relationship based graph 400 illustrated in FIG. 4, with reference to the networked system 200 illustrated in FIG. 2, the discovery of devices and device components in the networked system 200 and the determination of the relationships between the devices and device components result in the relationship based graph 400 including a route processor module 402 (corresponding to the route processor module 204a in the networked system 200), line modules 404 (corresponding to the line modules 204b, 204c, 204d, and 204e in the networked system 200) having a relationship with (e.g., a direct physical connection) the router processor module 402, ports 404a and 404b have a relationship with (e.g., provided on) the line modules 404, a port extender 406 (corresponding to the port extender 208 in the networked system 200) having a relationship with (e.g., a direct physical connection) the port 404b, a client IHS 408 (corresponding to the client IHS 206 in the networked system 200) having a relationship with (e.g., a direct physical connection) the port 404a, ports 406a and 406b that have a relationship with (e.g., provided on) the port extender 406, and a client IHS 410 (corresponding to the client IHS 206 in the networked system 200) having a relationship with (e.g., a direct physical connection) the port 404b. The relationship based graph 400 may be stored in a memory system in the system management IHS 202.

The relationship based graph may be stored in various formats for various deployment scenarios. In an embodiment, the relationship based graph may be stored in an application database or file system and provided to administrators and/or users access the same system management application instance. In another embodiment, the relationship based graph may be stored in a shared database and may be constructed by different instances of the system management application having access to the shared database. In another embodiment, the relationship based graph may be stored in a shared repository and may be constructed from different instances of the system management application having access to the shared repository within an enterprise. In another embodiment, the relationship based graph may be stored in a public cloud database and may be constructed from system management applications across different networked systems to allow sharing of workflows across enterprises.

As illustrated in FIG. 3, blocks 302, 304, and 306 of the method 300 may be repeated periodically by the system management application 202a to discover new devices as those new devices are connected to the networked system 200. As such, the relationship based graph 400 illustrated in FIG. 4 may be the graph upon connection of the system management IHS 202 to the networking IHS 204, or after a device (e.g., one of the client IHSs 206) has been added to the networked system 200. While the relationship base graph in the illustrated embodiment does not separate out the individual line modules 20b, 204c, 204d, and 204e in the networked system 200 as an optimization technique (e.g., only the active ports 404a and 404b on the aggregated line modules 404 in the relationship based graph 400 may be of interest), other situations may call for a redetermination of the relationship based graph 400 to individualize the line modules rather than providing them as a single entity (e.g., when a particular line module may be subject to an alarm while the other line modules may not).

The method 300 may then proceed to any or all of optional blocks 308, 310, 312, and 314, each of which utilizes the relationship based graph 400, and some of which may modify the relationship based graph 400 to dynamically create workflows that leverage the relationships determined in block 304. In some embodiments, the method 300 may proceed to optional block 308 where devices are provisioned using the relationships determined at block 304. For example, the connection of a device to the networked system 200 such as, for the example, the connection of the client IHS 206 to the line module 204e, may require that the client IHS 206, the line module 204e, and the route processor module 202 be configured. In response to the connection of the client IHS 206 to the line module 204e, the system management application 202a will detect the connection of the client IHS 206 to the networked system 200 and determine that a configuration of the client IHS 206 is required. The system management application 202a will then reference the relationship based graph 400 to determine that the client IHS 408 has a relationship with the port 404a that has a relationship with the line modules 404 (and those relationships correspond to the connections between the client IHS 206 and the line module 204e in the networked system), and the line modules 404 have a relationship with the route processor module 402 (corresponding to the route processor module 202 in the networked system). Those relationships may then indicate that the configuration of the client IHS 206 connected to the line module 204e will require configurations for the line module 204e and the route processing module 202. Thus, upon a first device (e.g., the client IHS 206) in the networked system 200 requiring configuration, the system management application 202a may determine the relationships between the first device and other devices (e.g., the line module 204e and the route processor module 202) in the networked system 200 and, in response, send an instruction to configure those other devices based on the required configuration of the first device. In an embodiment, such an instruction may be displayed on a display device of the system management IHS 202 for an administrator so that the administrator will know quickly and easily which devices in the networked system 200 must be configured in response to the required configuration of the first device. In another embodiment, such an instruction may be used to automatically configure (e.g., without administrator intervention) the other devices in response to the required configuration of the first device.

In a specific embodiment, a server IHS may be connected to a port on a network switch, and that server IHS may require configuration that includes details related to how the server IHS will communicate with other server IHSs on the network by establishing a network path, optimizing that network path, and/or a variety of other communication characteristics known in the art. For examples, port extender IHSs, line modules, and/or route processing modules in the communication path between the server IHSs may be provided an access list, have a VLAN configured, and or have a variety of other configurations elements provided on those devices to enable the server IHSs to communicate. Using the systems and methods discussed herein, upon the connection of the server IHS to the port on the network switch, instructions may be automatically sent from the system management application 202a that result in the configuration of the server IHS as well as the port extender, line modules, and the route processing module based on their relationships with the server IHS as determined in block 304 and included in the relationship based graph 400 in block 306. This provides improvements over conventional systems, which would require an administrator of the networked system to manually determine the affected networking devices and their components to accommodate a proposed configuration change.

In some embodiments, the method 300 may proceed to optional block 310 where devices are navigated using the relationships determined at block 304. For example, the route through the networked system 200 between the client IHS 206 connected to the line module 204e and the client IHS 206 connected to the port extender 208 through the line module 204b may be quickly and easily determined using the relationship based graph 400 created at block 306. The system management application 202a may reference the relationship based graph 400 to determine that the client IHS 408 has a relationship with the port 404a that has a relationship with the line modules 404 (and those relationships correspond to the connections between the client IHS 206 and the line module 204e in the networked system 200) that have a further relationship with the route processor module 402 (corresponding to the route processor module 202 in the networked system 200). The system management application 202a may also reference the relationship based graph 400 to determine that the client IHS 410 has a relationship with the port 406b that has a relationship with the port extender 406 (and those relationships correspond to the connections between the client IHS 206 and the port extender 208 in the networked system 200), and the port extender 406 has a relationship with the port 404b that has a relationship with the line modules 404 (and those relationships correspond to the connections between the port extender 208 and the line module 204b in the networked system 200) that have a further relationship with the route processor module 402 (corresponding to the route processor module 202 in the networked system 200). Those relationships allow for the optimized and quick navigation between the client IHSs 206 via the route processor module 202 through the line modules 204b/port extender 208 and the line module 204e.

In a specific example, an administrator may want to determine the route from a first server IHS connected to a networked system to a second server IHS connected to a networked system for the purposes of ensuring optimized network connectivity between the server IHSs. Such a route may be quickly and easily determined by leveraging the graph using the systems and methods discussed above. This provides improvements over conventional systems, which would require an administrator of the networked system to manually determine the network path for ensuring the optimized connectivity between the server IHSs.

In some embodiments, the method 300 may proceed to optional block 312 where devices are searched using the relationships determined at block 304. For example, an administrator of the networked system 200 may want to determine a particular client IHS 206 or IHSs 206 connected to the networked system 200. The administrator may then provide a descriptor for the desired client IHS 206 or IHSs 206 to the system management application 202a and, in response, the system management application 202a may use the relationship based graph 400 to determine one or more of the client IHSs 408 and 410 that correspond to the descriptor. In response to determining that one or more of the client IHSs 408 and 410 correspond to the descriptor, the system management IHS 202a may display on the a display device of the system management IHS 202 an identifier for the client IHS or client IHSs (e.g. the client IHS 206 connected to the line module 204e in the networked system 200), along with its relationships in the networked system 200 such as the relationship with the port 404a that has a relationship with the line modules 404 (corresponding to the connection between the client IHS 206 and the line module 204e) that further have a relationship with the route processor module 402 (corresponding to the route processor module 202 in the networked system 200.)

In a specific example, an administrator may want to find a particular server IHS or server IHSs connected to a networked system for the purposes of locating the server IHSs or in response to a network troubleshooting scenario. That server IHS or those server IHSs may be quickly and easily found and located using the systems and methods discussed above. This provides improvements over conventional systems, which would require an administrator of the networked system to physically label the server IHSs to allow for the determination of their current locations.

In some embodiments, the method 300 may proceed to optional block 314 where alarms are consolidated and/or correlated using the relationships determined at block 304. In the figures and discussion below, block 314 involves the dynamic creation of workflows using the relationship based graph 400 with regard to the viewing of alarms in the network system 200. However, as discussed below, the dynamic creation of workflows may be performed for a variety of other actions performed in the networked system 200 using the system management application 202a such as, for example, the configuration of devices, alarm navigation and correlation, topology navigation, locating devices in the network for various trouble shooting purposes, and/or a variety of other workflow scenarios known in the art.

Referring now to FIGS. 5 and 6, an administrator of the networked system 200 may use the system management application 202a on the system management IHS 202 to view all alarms in the networked system 200. In an embodiment, alarms in the networked system 200 may include, for example, alarms on a networking device, alarms on a line module, alarms on a port extender, alarms on ports, alarms on a client IHS, and/or a variety of other alarms known in the art. In response to the administrator providing an instruction to the system management application 202a to display all alarms in the networked system 202, the system management application 202a may use the relationship based graph 400 to determine that such an instruction is related to the route processor module 204a, the line modules 204b, 204c, 204d, and 204e, and the port extender 406 (e.g., devices in the networked system that are capable of providing an alarm to the system management application 202a.) In addition, the system management application may then modify the relationship based graph 400 illustrated in FIG. 4 to create a dynamic workflow 500 (e.g., a set of instructions to view all system alarms), illustrated in FIG. 5, that includes the view all alarms instruction 502 having relationships (in bold lines relative to the relationships according the relationship based graph 400) with each of the route processor module 402, the line modules 404, the ports 404a and 404b, the port extender 406, and the ports 406a and 406b. Those relationships may then be leveraged to consolidate/correlate alarms that are related. For example, the client IHS 408 may cause an alarm on the port 404a, which then may cause an alarm on a line module 404, which then may cause an alarm on the route processor module 402. Thus, alarms associated with the port 404a, the line modules 404 and the route processor module 402 may be consolidated/correlated. In another example, the client IHS 410 may cause an alarm on the port 406b, which then may cause an alarm on the port extender 406, which then may cause an alarm on a line module 404, which then may cause an alarm on the route processor module 402. Thus, alarms associated with the port 406b, the port extender 406, the line modules 404 and the route processor module 402 may be consolidated/correlated. In another example, during the course of communication between the clients IHSs 408 and 410, a configuration alarm may be set off in both ports 404a and 406b due to their not being configured, and using the graph the system management application may determine that such a configuration alarm is likely due to the communication between client IHSs 408 and 410.

FIG. 6 illustrates an embodiment of a system management IHS 600, which may be the system management IHS 202 of FIG. 2, including a display device 602 displaying a networked system reporting screen 604 that is provided in response to the request by the administrator to view all alarms in the networked system 200. The networked system reporting screen 604 has been created by the system management application 202a using the relationship based graph 400 and dynamic workflow 500 and includes a route processor module section 606 that displays all alarms associated with the route processor module 204a, a line module section 608 that displays all alarms associated with the line modules 204b, 204c, 204d, and 204e, and a ports/port extender section 610 that displays all alarms associated with ports on the line modules 204b, 204c, 204d, and 204e and the port extender 208. The networked system reporting screen 604 includes a related actions section 612 including a view all alarms link 614 that is created by the system management application 202a and that, upon future selection by the administrator, will cause the system management application 202a to run the dynamic workflow 500 to provide the view all alarms link 614.

Referring now to FIGS. 7 and 8, an administrator of the networked system 200 may use the system management application 202a on the system management IHS 202 to view alarms associated with line modules in the networking IHS 202. In response to the administrator providing an instruction to the system management application 202a to display alarms associated with the line modules in the networking IHS (e.g., by selecting the line module section 608 on the networking system reporting screen 604), the system management application 202a may use the relationship based graph 400 to determine that such an instruction is related to the line modules 204b, 204c, 204d, and 204e, the port extender 406, and the clients IHSs 408 and 410 (e.g., devices in the networked system that are capable of producing an alarm from the line modules 204b, 204c, 204d, and 204e to the system management application 202a). In addition, the system management application may then modify and leverage the relationship based graph 400 illustrated in FIG. 4 and/or the dynamic workflow 500 illustrated in FIG. 5 to create the dynamic workflow 700 that includes the view line module alarms instruction 502 having relationships (in bold lines relative to the relationships according the relationship based graph 400 and the dynamic workflow 500) with each of the line modules 404, the ports 404a and 404b, the port extender 406, the ports 406a and 406b, and the client IHSs 408 and 410. Those relationships may then be leveraged to consolidate/correlate alarms that are related. For example, the client IHS 408 may cause an alarm on the port 404a, which then may cause an alarm on a line module 404. Thus, alarms associated with the port 404a and the line modules 404 may be consolidated/correlated. In another example, the client IHS 410 may cause an alarm on the port 406b, which then may cause an alarm on the port extender 406, which then may cause an alarm on a line module 404. Thus, alarms associated with the port 406b, the port extender 406, and the line modules 404 may be consolidated/correlated.

FIG. 8 illustrates an embodiment of the system management IHS 600 displaying a networked system reporting screen 800 that is provided in response to the request by the administrator to view line module alarms in the networked system 200. The networked system reporting screen 800 has been created by the system management application 202a using the relationship based graph 400 and dynamic workflow 700 and includes a line module section 802 that displays all alarms associated with the line modules 204b, 204c, 204d, and 204e, a ports/port extender section 804 that displays all alarms associated with ports on the line modules 204b, 204c, 204d, and 204e and the port extender 208, and a client IHSs section 806 displaying all alarms associated with client IHSs 206. The networked system reporting screen 800 includes the related actions section 612 with a view line module alarms link 808 that is created by the system management application 202a and that, upon future selection by the administrator, will cause the system management application 202a to run the dynamic workflow 700 to provide the networked system reporting screen 800.

Referring now to FIGS. 9 and 10, an administrator of the networked system 200 may use the system management application 202a on the system management IHS 202 to view alarms associated with port extender in the networking IHS 202. In response to the administrator providing an instruction to the system management application 202a to display alarms associated with the port extender 208 in the networked system 200 (e.g., by selecting the ports/port extender section 610 or 804 on the networking system reporting screens 604 or 800, respectively), the system management application 202a may use the relationship based graph 400 to determine that such an instruction is related to the port extender 406 and the client IHS 410 (e.g., devices in the networked system that are capable of producing an alarm from the port extender 208 to the system management application 202a). In addition, the system management application may then modify the relationship based graph 400 illustrated in FIG. 4, the dynamic workflow 500 illustrated in FIG. 5, and/or the dynamic workflow 700 illustrated in FIG. 7, to create a dynamic workflow 900 that includes the view port extender alarms instruction 902 having relationships (in bold lines relative to the relationships according the relationship based graph 400 and the dynamic workflows 500 and 700) with each of the port extender 406, the ports 406a and 406b, and the client IHS 410. Those relationships may then be leveraged to consolidate/correlate alarms that are related. For example, the client IHS 410 may cause an alarm on the port 406b, which then may cause an alarm on the port extender 406. Thus, alarms associated with the port 406b and the port extender 406 may be consolidated/correlated.

FIG. 10 illustrates an embodiment of the system management IHS 600 displaying a networked system reporting screen 1000 that is provided in response to the request by the administrator to view port extender alarms in the networked system 200. The networked system reporting screen 1000 has been created by the system management application 202a using the relationship based graph 400 and dynamic workflow 900 and includes a port extender section 1002 that displays all alarms associated with the port extender 208, a ports section 1004 that displays all alarms associated with ports on the port extender 208, and a client IHSs section 806 displaying all alarms associated with client IHS 206 connected to the port extender 208. The networked system reporting screen 800 includes the related actions section 612 with a view port extender alarms link 1008 that is created by the system management application 202a and that, upon future selection by the administrator, will cause the system management application 202a to run the dynamic workflow 900 to provide the networked system reporting screen 1000.

The dynamic workflows 500, 700, and 900 provided in FIGS. 5, 7, and 9 have been provided for a simplified networked system in order to provide clarity of illustration and discussion, but one of skill in the art should recognize that in a complicated, real-world networked system with a relatively large number of devices and device components, relationship based graphs and dynamic workflows may become very large and complicated in their relationships. While such systems and their associated relationship based graphs and workflows are too complicated and large to provide herein, such systems, graphs, and workflows are envisioned as falling within the scope of the present disclosure.

Thus, systems and methods have been described that provide a system management application on a system management IHS that operates to determine the relationships between each of the devices and their device components in a networked system. Those relationships may then be leveraged to quickly and easily provision/configure a first device in the networked system by not only configuring that first device, but also configuring other devices related to that first device that need configuration based the configuration and/or operation of the first device. Those relationships may also be leveraged to quickly and easily navigate through the networked system between devices, search for devices and provide those devices along with their related devices, and consolidate/correlate alarms that may be provided by a number of related devices in the networked system. Furthermore, new relationships may be created between devices in response to instructions by a user in order to dynamically create workflows for the networked system.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A system management information handling system (IHS), comprising:
a processing system; and
a memory system that is coupled to the processing system and that includes instructions that, when executed by the processing system, cause the processing system to:
discover a plurality of devices in a networked system;
determine a plurality of relationships between the plurality of devices;
store the plurality of relationships in the memory system;
determine that a first device of the plurality of devices requires configuration;
determine that the first device has a relationship with at least one second device of the plurality of devices using the plurality of relationships stored in the memory system; and
send an instruction to configure the at least one second device having the relationship with the first device according to the configuration required for the first device.

2. The system management IHS of claim 1, wherein the instruction to configure the at least one second device provides for the automatic configuration of the at least one second device according to the configuration required for the first device.

3. The system management IHS of claim 1, wherein the instruction to configure the at least one second device is displayed on a display device.

4. The system management IHS of claim 1, wherein the determining the plurality of relationships between the plurality of devices includes determining a plurality of relationships between device components in at least one of the plurality of devices.

5. The system management IHS of claim 1, wherein the memory system includes instructions that, when executed by the processing system, cause the processing system to:
correlate alarms associated with at least two devices of the plurality of devices using a relationship between the two devices that is stored in the memory system.

6. The system management IHS of claim 1, wherein the memory system includes instructions that, when executed by the processing system, cause the processing system to:
route between two devices of the plurality of devices using at least some of the plurality of relationships stored in the memory system.

7. The system management IHS of claim 1, wherein the memory system includes instructions that, when executed by the processing system, cause the processing system to:
receive a request to find a device of the plurality of devices in the networked system; and
display the requested device along with at least one other device of the plurality of devices that has a relationship with the requested device that is stored in the memory system.

8. A networked system, comprising:
a first information handling system (IHS) including a plurality of first IHS components;
a second IHS coupled to the first IHS;
a system management IHS coupled to the first IHS and operable to:
discover the first IHS and the second IHS;
determine a plurality of relationships between the first IHS components and the second IHS;
store the plurality of relationships;
determine that the second IHS requires configuration;
determine that the at least some of the first IHS components have a relationship with the second IHS using the plurality of relationships; and
send an instruction to configure the at least some of the first IHS components having the relationships with the second IHS according to the configuration required for the second IHS.

9. The networked system of claim 8, wherein the instruction to configure the at least some of the first IHS components provides for the automatic configuration of the at least some of the first IHS components according to the configuration required for the second IHS.

10. The networked system of claim 8, wherein the instruction to configure the at least some of the first IHS components is displayed on a display device.

11. The networked system of claim 8, wherein the first IHS is a networking IHS and the first IHS components include a route processing module, at least one line module, and at least one port.

12. The networked system of claim 8, wherein the system management IHS is operable to:
correlate alarms associated with the second IHS and at least one of the first IHS components using a relationship between the second IHS and the at least one of the first IHS components.

13. The networked system of claim 8, further comprising:
a third IHS coupled to the first IHS, wherein the system management IHS is operable to:
discover the third IHS;
determine a plurality of relationships between the first IHS components and the third IHS;
store the plurality of relationships; and
route between the second IHS and the third IHS using at least some of the plurality of relationships.

14. The system management IHS of claim 1, wherein the system management IHS is operable to:
receive a request to find the second IHS; and
display the second IHS along with the first IHS components that have a relationship with the second IHS.

15. A method for managing a networked system, comprising:
discovering a plurality of devices in a networked system;
determining a plurality of relationships between the plurality of devices;
storing the plurality of relationships in a memory system;
determining that a first device of the plurality of devices requires configuration;
determining that the first device has a relationship with at least one second device of the plurality of devices using the plurality of relationships stored in the memory system; and
sending an instruction to configure the at least one second device having the relationship with the first device according to the configuration required for the first device.

16. The method of claim 15, wherein the instruction to configure the at least one second device provides for the automatic configuration of the at least one second device according to the configuration required for the first device.

17. The method of claim 15, wherein the determining the plurality of relationships between the plurality of a devices includes determine a plurality of relationships between device components in at least one of the plurality of devices.

18. The method of claim 15, further comprising:
correlating alarms associated with at least two devices of the plurality of devices using a relationship between the two devices that is stored in the memory system.

19. The method of claim 15, further comprising:
routing between two devices of the plurality of devices using at least some of the plurality of relationships stored in the memory system.

20. The method of claim 15, further comprising:
receiving a request to find a device of the plurality of devices in the networked system; and
displaying the requested device along with at least one other device of the plurality of devices that has a relationship with the requested device that is stored in the memory system.
